(19) United States
(12) Patent Application Publication
(10) Pub. No.: US 2008/0046305 A1
(43) Pub. Date: Feb. 21, 2008

(54) AUTOMATED AUCTION METHOD FOR STAFFING WORK SHIFTS

(76) Inventors: Luis Garcia, Slinger, WI (US); Bryan D. Dickerson, Hartford, WI (US); James A. Hennen, Hartford, WI (US); Christopher H. Daute, Hartford, WI (US)

Correspondence Address: QUARLES & BRADY LLP, 411 E. WISCONSIN AVENUE, SUITE 2040, MILWAUKEE, WI, 53202-4497, US

(21) Appl. No.: 11/876,461

(22) Filed: Oct. 22, 2007

Related U.S. Application Data
(63) Continuation of application No. 11/077,458, filed on Mar. 10, 2005.

(51) Int. Cl. G06Q 10/00; G06Q 20/00

(52) U.S. Cl. 705/9; 705/14; 705/39

(57) ABSTRACT

A procedure is provided by which a worker is able to alter his or her work schedule using a computer system. The worker accesses work shift positions that have been designated as being alterable and chooses one as a selected work shift position. That selection may also specify a wage at the worker is willing to be compensated for staffing the selected work shift position. The computer system determines whether the worker is qualified to perform the tasks associated with the selected work shift position. If qualified, the worker is scheduled into the selected work shift position. The computer system also may provide a mechanism by which two workers can trade previously scheduled work shift positions.

### CROSS-REFERENCE TO RELATED APPLICATIONS

This application is a continuation of U.S. application Ser. No. 11/077,458 filed on Mar. 10, 2005.

### STATEMENT REGARDING FEDERALLY SPONSORED RESEARCH OR DEVELOPMENT

Not Applicable

### BACKGROUND OF THE INVENTION

1. Field of the Invention

The present invention relates to computer systems for scheduling employees into work shift positions, and more particularly to a computer system that permits an employee and/or an employment agency to bid on filling a vacant work shift position.

2. Description of the Related Art

Large employers utilize computerized scheduling systems which assign workers to different work shifts during a future wage period. The resultant work schedule is printed and provided to each employee prior to the wage period, thus informing the employee when to report for work and the duration of each work period. In many businesses, an employee's work schedule varies from day to day and week to week. In a hospital for example, an employee may work eight hours during each of five consecutive days during one week, and then may work three twelve hour days the following week. Certain employees may be part-time, in which case they work less than an eight hour day. In addition, some employees are not assigned to a specific department, but float wherever workers are needed on a given day and these floating employees often work varying amounts of time depending upon the quantity of work being done.

Labor wage and hour laws restrict the number of hours that certain classes of employees may work during given time periods. In other cases, when a defined number of hours have been worked during a specified time period, the employee must receive a higher level of compensation for additional work hours in that period. Failure to abide by these laws can result in the government assessing stiff penalties against the employer.

In addition, union contracts often require that a covered employee be compensated at different rates depending upon the number of hours worked either within a given wage period, a calendar week or a specified number of consecutive days. Failure to abide by these overtime compensation rules may violate the terms of the contract and result in the assessment of penalties. Many employers also have developed their own rules which provide additional compensation to employees in certain circumstances based on the number of hours worked. All of these factors must be taken into account when scheduling employee work assignments.

When it is known ahead of time that an employee will be absent, due to vacation, a planned medical treatment or the like, that employee is removed from the pool of people who may be scheduled to work during that period of time. Therefore, automated scheduling program fills the work shift positions with only the available employees from that pool. However, a replacement worker may not be readily available from the group of employees that normally work a given job or in a particular department. In that situation a replacement worker must be found from another source, such as another department or from a temporary employment agency. Heretofore the automated scheduling system did not accommodate searching elsewhere for an available employee and supervisors used manual methods to fill vacant work shift positions. Thus it is desirable to automate this aspect of the process for scheduling workers from outside the normal pool of employees.

When filling a work shift position with a person outside the normal pool, the employer must ensure that the candidates are qualified to perform the tasks associated with that position. Certain positions may require that the workers have special certifications and licenses, in addition to being compatible with co-workers.

It is in the best interests of the employer to fill work shift positions with the most cost effective workers. Therefore, if several employees are available to work a given position, a qualified employee at the lowest hourly wage level should be used. Part time employees and others seeking to work more hours may be willing to do so at a lower than usual wage in order to make more money. Thus it may be useful to have employees bid on filling a vacant work shift position and select the person willing to work at the lowest hourly wage. However, additional factors must be considered besides the hourly wage being bid. For example, working additional hours may entitle the employee to overtime compensation, which thereby increases the actual hourly rate above the bid amount.

### SUMMARY OF THE INVENTION

An entity, such as an employee or an employment agency, is able to assign themselves to a work shift position that is part of a work schedule at a business. The work schedule is stored in a computer system that also contains a profile record which identifies qualifications of each entity. The process involves electronically designating at least one of a plurality of work shift positions as an available work shift position that is able to be assigned. Criteria data identifying qualifications that a person must possess in order to work at the available work shift position also is stored in the computer system.

The entity electronically chooses a designated available work shift position as a selected work shift position. The computer system disqualifies the entity from being assigned to any available work shift position for which the qualifications of the entity in the profile record fail to satisfy the criteria data of that available work shift position. If the entity is not disqualified from working the selected work shift position, the computer system schedules the entity into the selected work shift position.

An aspect of the present invention involves the entity specifying a wage at which the entity is willing to be compensated for performing the selected work shift position. In this case, scheduling the entity for the selected work shift position is based on the wage specified. For example, the entity that is willing to work at the lowest wage is scheduled for the selected work shift position.

Another aspect of the present invention provides a procedure by which a worker is able to automatically exchange a scheduled work shift position with a work shift position that has been assigned to another worker.

A further aspect of present invention involves rewarding entities that participate in the system for scheduling work shift positions. For example, an entity is awarded different numbers of points which can be accumulated and used to obtain perquisites from the employer. Different perquisites cost different amounts of points.

### BRIEF DESCRIPTION OF THE DRAWINGS

FIG. 1 is a schematic diagram of a computer system for scheduling people into work shift positions and for worker recording time and attendance data;

FIG. 2 represents a data file stored in the computer system and containing information about an employee;

FIG. 3 depicts a work schedule showing information about each work shift position to be staffed;

FIG. 4 is a flowchart of a process by which an employee or an employment agency bids on filling a vacant work shift position in the work schedule;

FIG. 5 is a flowchart of a computerized procedure by which employees trade scheduled work shift positions; and

FIG. 6 is a flowchart of a process by which one employee chooses to replace another employee who has been scheduled for a work shift position.

### DETAILED DESCRIPTION OF THE INVENTION

Although the present invention is being described in the context of use with hospital employees, it should be understood that the inventive concepts can be applied to any type of business or organization having work positions that required staffing with people. For example, this novel method can be utilized to schedule volunteers working at an event.

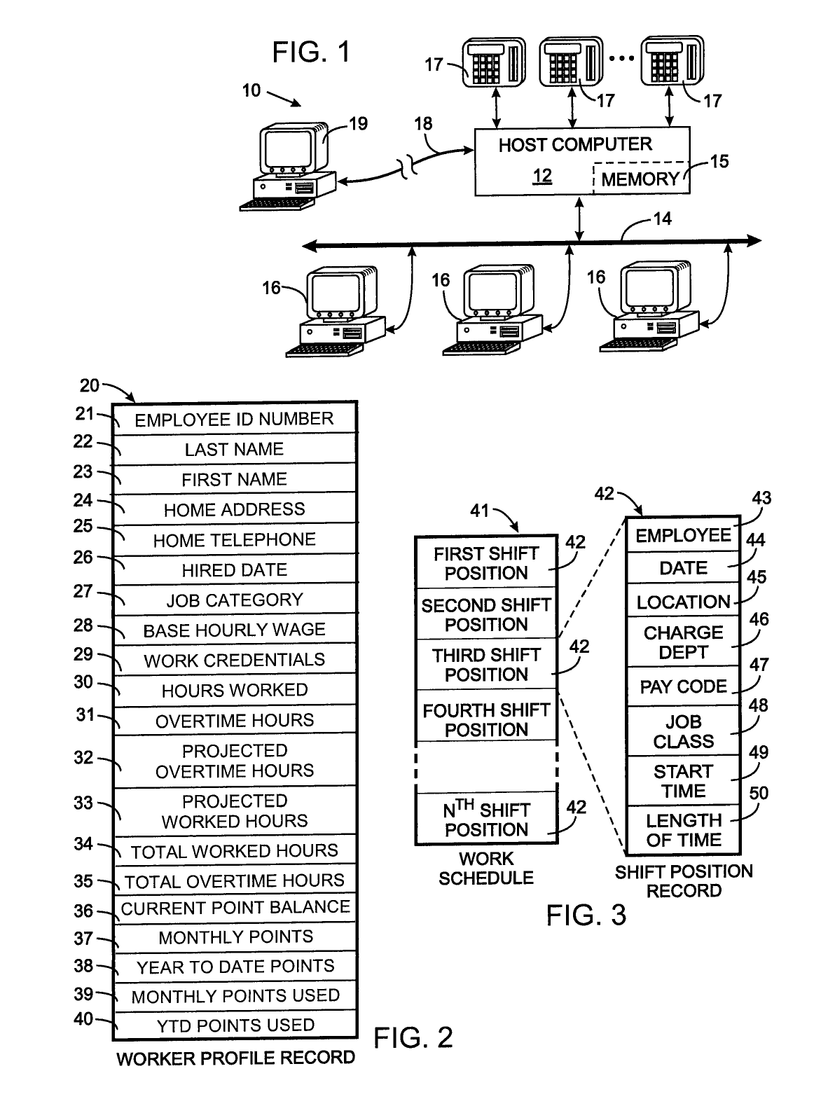

FIG. 1 illustrates a system 10 for scheduling employees into work shift positions and then recording the actual time worked by each employee. This system comprises a host computer 12 which executes software programs that perform those functions, and stores the work schedules and the time and attendance data. The host computer is connected to a standard local area network (LAN) 14 of a type commonly found in work places. A plurality of personal computers 16 are connected to the local area network 14 to exchange data and commands with the host computer 12. Other remote personal computers 19 are able to access the host computer 12 via the Internet 18, thereby enabling employees and authorized people to access the host computer 12 from remote locations.

A plurality of badge readers 17, through which employees indicate when they start and end periods of work, are located throughout the business and are connected to the host computer 12. The badge readers 17 can take any of a number of commercially available forms. For example, each employee identification badge has a magnetic strip that encodes a unique employee number and the magnetic strip is scanned when the employee swipes the identification badge through a slot of a badge reader. Each badge reader 17 also has a keypad by which an employee number or other information can be entered into the time and attendance function performed by the computer system 10. A display device of the card readers 17 presents information to the employee.

Supervisory personnel use the personal computers 16 to enter employee scheduling information into the host computer 12 and subsequently check and manually alter the work schedule as necessary. For example, when an employee calls in sick, a supervisor changes the schedule to substitute another employee for the absent worker. Supervisors also utilize the personal computers 16 to monitor attendance and the actual hours worked by the employees. Such monitoring identifies when an employee is anticipated to work overtime and allows a supervisor to alter the work schedule to avoid unnecessary or unwanted overtime and the additional compensation expense.

The personal computers 16 enable appropriate personnel to access a standard employee staffing and scheduling program, such as the ActiveStaffer® Series available from API Software Inc. of Hartford, Wis., U.S.A. This software program provides a listing of all the employees available for assignment to a given department and each employee's work preferences, such as a work shift, vacation schedule, and the like. This enables the employees to be assigned to specific work shifts and to an amount of time during each shift, either automatically by the computer program or manually by a supervisor. Some employees may work eight hour shifts, while others have twelve hour shifts. The schedule for all the employees is stored in a work schedule data file within the memory 15 of the host computer 12. The term “memory” as used herein generically covers types of storage devices which as accessible by a computer including, but not limited to, electronic memory devices and apparatus that use magnetic or optical storage media.

With reference to FIG. 2, the memory 15 of the host computer 12 stores an worker data file containing a profile record 20 for each worker at the facility. Every worker profile record 20 has a plurality of data fields with field 21 storing the person's employee identification number and fields 22 and 23 contain the last and first names of the employee. The person's home address and telephone number appear in fields 24 and 25. The date that the individual was hired is held in field 26. The employee's regular job category is identified in field 27 with his/her base hourly wage being given in field 28. Any special work credentials, such as training, licenses, certifications, and the like are identified in Field 29.

The remainder of the worker profile record 20 contains information about the time worked by the individual. Fields 30 and 31 store the number of regular and overtime hours that the person has actually worked during the current pay period. The projected number of overtime hours expected to be worked during the current pay period is stored in field 32, while field 33 specifies the number of total hours projected to be worked. Fields 34 and 35 respectively contain year-to-date totals of the regular hours actually worked and overtime hours actually worked.

As will be described, an optional feature of the present method by which an employee bids to work on unfilled work shift positions includes a system for rewarding the people who participate in that auction. A person is awarded different numbers of points as a reward for performing various functions of the work shift assignment process. The employee may spend his or her points toward selected perquisites from the employer. The points accumulated by the employee are tabulated in that person's worker profile record. Specifically, field 36 holds a value indicating the total number of points currently available for the employee to spend. Fields 37 and 38 indicate the total number of points that the employee has received during the present month and during the current fiscal year, respectively. Field 39 indicates the number of points that the employee has spent during the present month, while Field 40 tracks such spending for the current fiscal year. Additional fields may be provided to tabulate the aggregate number of points acquired and spent during the person's entire term of employment.

With reference to FIG. 3, the host computer 12 also executes a program, such as the ActiveStaffer® Series available from API Software, Inc. of Hartford, Wis., U.S.A., to schedule employees to work in the different shifts during every work day. This process creates a work schedule file 41 containing a separate record for each work shift position 42 needing to be filled by an employee. Each work shift position 42 has a plurality of data fields 43-50 that contain information about that position. Specifically, field 43 stores a designation of the employee who is scheduled to perform the associated job and initially when the work shift positions are defined, this field 43 remains blank until a supervisor schedules a worker. A second field 44 designates the date of the work shift position and a third field 45 specifies the location where the work is to be performed. A fourth field 46 identifies the department which is to be charged for the time worked while a fifth field 47 holds either the hourly wage for this position or a pay code that defines the wage. The sixth data field 48 in the shift position record specifies the job class (e.g. nursing supervisor, a registered nurse, a licensed practical nurse or a nursing aid) associated with this position. The job class identifies the qualification that a person must possess in order to perform the associated work shift position. The seventh and eighth fields 49 and 50 define the start time and duration of the work shift position. Preferably the duration is specified by the length of the shift (e.g. a number of hours), but alternatively the duration is indicated by the scheduled end time of the work period. Although reference is made herein to work shifts and work shift positions, it is to be understood that the work period for which a person in scheduled may be less than or greater than a conventional eight hour shift. In fact, work shift positions of a variety of different durations typically are found in the work schedule for any given day.

In order to schedule employees for an upcoming work period, a supervisor uses a personal computer 16 interface with the scheduling program that accesses the work schedule file 41. The supervisor designates the desired future pay period along with a department to be staffed and the scheduling program displays the corresponding work shift positions on the monitor of the personal computer 16. The software may also display a list of employees available to fill a given work shift position in this department. The supervisor then designates an employee for each vacant position.

However, there may be occasions in which there are no employees available for a given work shift position, or in which using an available employee who is assigned to this department will result in overtime expenditures. In such cases, the employer historically would look to other sources, such as a temporary employment agency or a worker from another department to fill the vacant work shift position. These alternative staffing processes typically were performed manually and involved the supervisor either contacting a manager of another department to locate an available employee or going through the human resources department to obtain a temporary worker from an employment agency. Such alternative staffing methods were relatively time consuming for all parties involved.

With the present scheduling system, when a work shift position 42 cannot be filled by readily available employees, the supervisor designates that work shift position in the work schedule 41 is to be submitted to an auction. This makes the work shift position open for other employees and authorized employment agencies to submit bids for filling that position. The bids are reviewed and one is selected. The computer system then schedules the respective work shift position with the entity that submitted the selected bid.

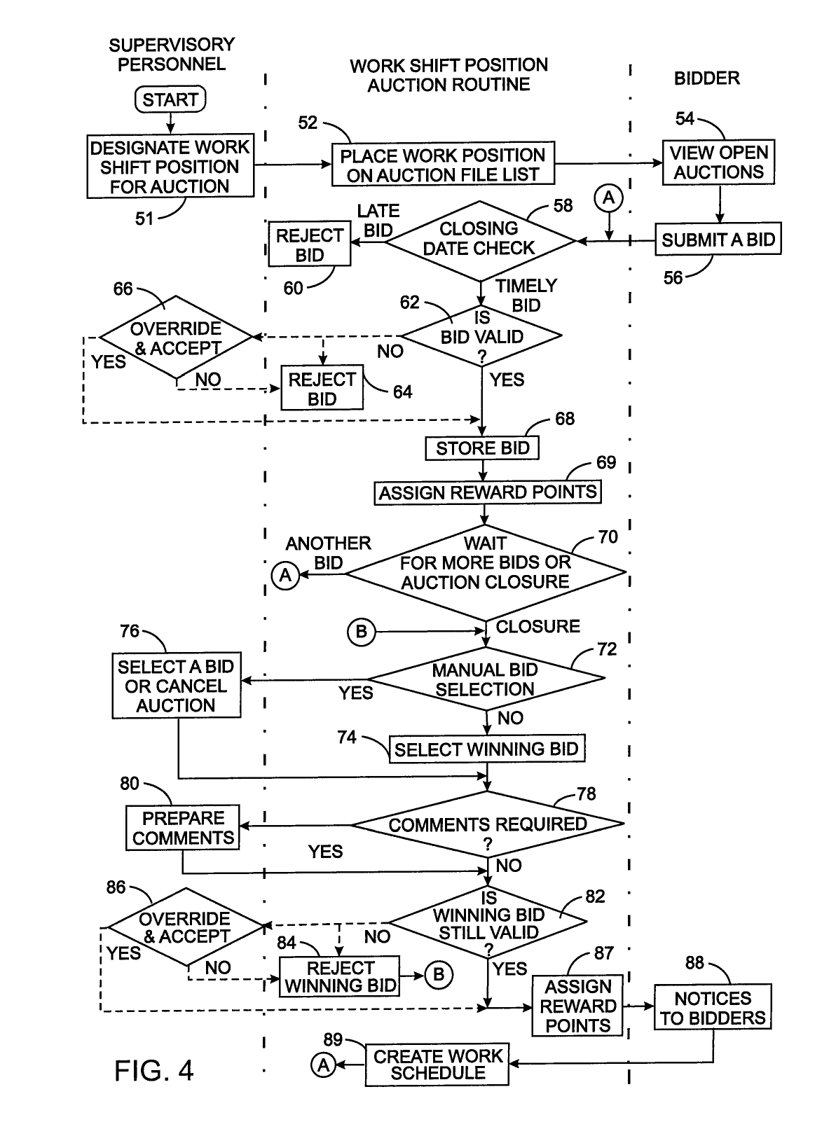

With reference to FIG. 4, the auction process is implemented as part of a work schedule alteration software program that is executed as an adjunct to the main scheduling program. The process commences at step 51 with the supervisor designating a work shift position as available for auction and the last date on which bids will be accepted. The supervisor may also specify special qualifications that a bidder must possess in addition to those contained within the shift position record 42. The designation is conveyed to the host computer which at step 52 automatically places that position on a list of all positions available for bidding. The auction list is maintained as a data file within the memory 15 of the host computer 12. Each entry on the auction list points to the associated shift position record 42 so that prospective bidders are able to view detailed information about each position to determine if they are qualified to work it. Alternatively, when a particular employee accesses the auction list, the software utilizes that employee's work credentials from field 29 of the worker profile record 20 and other information about the employee to select and display only the available work shift positions for which that employee is qualified.

When an employee desires to participate in the auction, he or she uses a personal computer 16 within the workplace or a remote computer 19 connected to the internet 18 to access the work shift position auction routine on the host computer 12. An employment agency, which has been approved by the employer to participate in these auctions, also can access the work shift position auction routine from a remote computer 19. Regardless of the entity participating in the auction or the manner in which the host computer 12 is accessed, such access at step 54 enables the entity to view the various work shift positions which have been designated as available for auctioning. The person then reviews those available shift positions to determine for which ones he or she is qualified and available to work. Then at step 56, the entity submits a bid designating the submitter, the specific work shift position, and an hourly rate at which that entity is willing to work.

The bid is transmitted to the host computer 12 where the work shift position auction routine initially checks the date of submission against the closing date for the bidding process on that particular work shift position. If at step 58, a determination is made that the closing date for this particular position has passed, i.e. the bid is late, the bid is rejected at step 60 and the submitter is notified of the late bid rejection by a return message sent to the originating personal computer 16 or 19.

If the bid was timely submitted, the auction routine advances to step 62 where the qualifications of the bidder are examined against the requirements for the particular work shift position to determine whether the bid is valid. Only approved employment agencies are able to submit bids in which case the submitter is screened against a list of currently approved agencies with the assumption that the agency will fill the position with a qualified employee. Failure to use qualified people results in the removal from the list of approved employment agencies for future bidding. For bids submitted by an employee, that person's worker profile record is inspected and particularly, the work credentials in field 29 (FIG. 2) to ensure that the individual's qualifications satisfy the requirements for the particular work shift position on which the bid has been placed. In other words, the bidder's work credentials are compared against those associated with the particular job class designated in the sixth field 48 of the shift position record (FIG. 3) and any other requirements specified by the supervisor upon designating the work shift position for auction. If based on this review of the bid, a determination is made that the submitting entity is not properly qualified, the process can either branch to step 64 where the bid and its submitter are automatically disqualified, or the software can be configured to branch to step 66 at which supervisory personnel are notified of the invalid bid. Such supervisory personnel may be either the supervisor who placed the respective work shift position for auction or another designated person at the business. The person receiving the notice at step 66 then manually reviews the bid against the requirements of the work shift position and is afforded the opportunity to either reject the bid or override the automated rejection and accept the bid. For example, although the work shift position ordinarily requires a licensed practical nurse, if none of the bidders are so licensed, the supervisor may decide to staff the position with a nursing assistant rather than have the position go unstaffed. In another situation, a person presenting a bid may be deficient in only a minor qualification that is that not essential to perform the particular job. When a determination is made at either step 62 or 66 to accept the bid, the procedure advances to step 68 where the bid is stored along with any other bids that have been received.

The auction process optionally provides an incentive program to encourage participation. Employees receive reward points for taking part in different functions of the auction process. The employees accumulate reward points which can be spent at hospital stores, shops, cafeterias and other food establishments in place of money, in which case the points have a monetary equivalent. Points could also be used for other perquisites, such as preferred parking locations and preference in scheduling vacation time. Thus when a bid has been accepted a corresponding number of reward points is added at step 69 to the current point balance, monthly point balance and year to date point balance in fields 36, 37 and 38, respectively, in the worker profile record 20, see FIG. 2. The number of points may vary depending upon the characteristics of the shift upon which the bid was placed. For example, less desirable work shift positions may earn the employee a greater number of points. Thereafter, when the employee spends points, that number of points is deducted from the value in the current point balance field 36 and is added to fields 39-40 to update the number of points used by that employee. That adjustment of spent points is performed by the hospitals accounting department via one of the personal computers 16. A deduction to the employee reward point balances in fields 36-38 may be made when the employee fails to work an assigned work shift. The deduction can be made by an authorized department supervisor or payroll personnel using a computer 16. Employees are able to view their reward points balances at a card reader 17 or personal computer 16 (FIG. 1) or by accessing the employer's Internet site.

Referring again to FIG. 4, after the newly entered bid has been stored, the work shift position auction routine typically then loops back at step 70 to process additional bids.

When the time period for accepting bids on a particular work shift position has elapsed, the work shift position auction routine advances to step 72. Now, a determination is made from the configuration of the routine or from a flag stored with the particular work shift position data whether the bids are to be reviewed manually by the supervisor or automatically processed by the software. When manual bid selection has not been indicated, the program execution branches to step 74 where the software automatically selects the first bid that was received at the lowest hourly wage. Alternatively when manual bid selection is designated, the procedure branches to step 76 where the bids that have been received for a particular work shift position are sent to the supervisor designated to review them. That supervisor receives notification of bids waiting for review by either an email or a notice the next time the supervisor logs into the work schedule alteration software program. In either case, the supervisor then accesses the auction routine which displays all the bids for each work shift position awaiting review and after perusing those bids, selects one for staffing the open position. This allows the bid selection to be based on criteria other than only the lowest wage tendered and enables the supervisory personnel to take into account the compatibility of a bidder with other workers during that shift and other characteristics of each bidder. For example, a bid from a person possessing qualifications that exceed the requirements for a given work shift position may be accepted over a bid from a person who merely meets the minimum requirements, even though the selected bid may be at a slightly higher wage. In another case, the supervisor may select the bid from an employee over one at a slightly lower wage from an employment agency, in order to maintain good employee moral. Alternatively, if none of the submitted bids is satisfactory, the supervisor may cancel the auction and not select a person to fill the vacant work shift position. In that event, all the bidders and the supervisor who offered the position for auction are notified of the cancellation.

Once the winning bid selection has been made, the program execution advances to step 78 where a determination is made whether comments are required to be sent to either the winning or losing bidders. This determination is based on either a designation that was made at the time the particular work shift position was sent to auction, or a universal configuration parameter designating that comments are to be sent to the losing bidders. Typically, comments are required when the manual selection process is utilized as the selection may be based on subjective factors, other than the lowest wage bid. If comments are required, a designated supervisor is notified and enters the comments at step 80. There may be no need to submit a comment to the selected bidder as very little explanation typically is required.

Then the shift bidding process advances to step 82 where the selected bid is automatically reviewed to determine whether it still is valid. Because a period of time has elapsed between when the bid was validated upon submission at step 62 and the selection at step 74 or 76, the circumstances related to the bid submitter may have changed in the interim. For example an employment agency or employee now may be disqualified because of a disciplinary action, or an employee may have worked additional hours in the interim which will entitle that person to overtime compensation above the hourly wage bid for the auction position. In these instances, the winning bid may be declared invalid. If the selected bid is now invalid at step 82, the shift bidding process branches either to step 84 to automatically reject the bid or to step 86 to allow a supervisor to review and override the invalidity determination. For example, the supervisor may accept the bid knowing that doing so will entitle the employee to overtime compensation. If the supervisor affirms the invalidity, the bid is rejected at step 84 before returning to step 72 to select a different bid for the work shift position.

Once a winning bid has been validated at either step 82 or 86, an associated amount reward points is added at step 87 to balances in fields 36, 37 and 38 in the worker's profile record 20. Then the appropriate notices are sent to all the bidders at step 88. Next the winning bidder is scheduled at step 89 by inserting the respective employee identification into the first field 43 of the shift position record 42 within the work schedule 41 of FIG. 3. The bidding procedure then returns to step 58 to process any other bids.

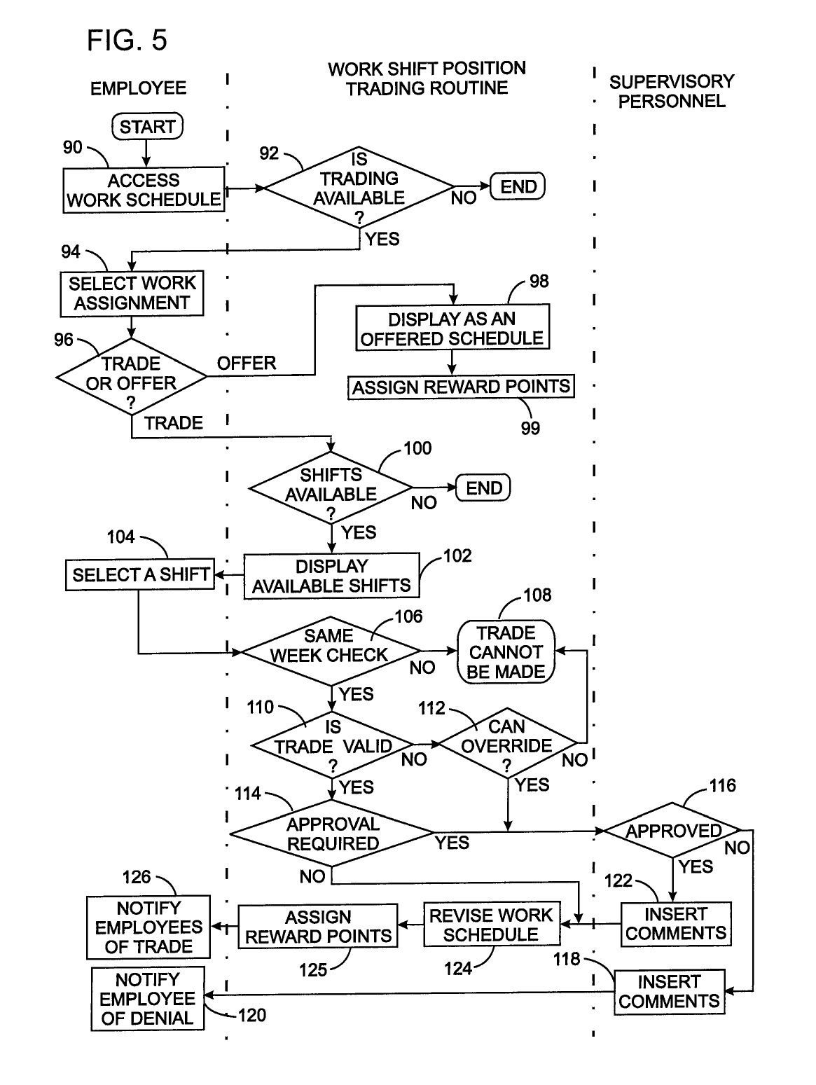

After a schedule has been created, either with or without work shift bidding, an employee also is able to access his or her work schedule which has been stored in the host computer. The present scheduling system also allows an employee to trade scheduled work assignments with another employee, or to offer a scheduled work assignment to any other employee within the business without accepting an assignment in return. The procedure for doing so is depicted by the flowchart of FIG. 5.

This procedure commences at step 90 with the employee utilizing a personal computer 16 or 19 to access the host computer 12 and display his or her work schedule that was created previously. That computer display includes a button which can be activated using the computer mouse to enter the scheduled assignment trading portion of the work schedule alteration software program. At step 92, the software determines whether this employee is authorized to change his or her work schedule. Certain employees, such a recent hire, one on probation, or one who has abused the trading process in the past, are not authorized to trade work assignments in this automated manner which may not require supervisor approval. The procedure terminates immediately if one of these employees attempts to use the work shift position trading routine of the present program.

Assuming that the present employee is permitted to use the trading routine, at step 94 a particular scheduled work shift position is selected. Then at step 96 a designation is made whether the work shift position is to be traded for a different work shift position assigned to another employee, or whether the scheduled work shift position is merely being offered for any other employee to take without accepting a work shift position in exchange. Trading is utilized in situations where both employees have agreed to swap scheduled work shift positions. Offering a work assignment may be utilized when either an employee merely wants to give up a scheduled work shift position without assuming one in exchange, or when the employee has not found another employee with whom to exchange work shift positions.

To make an offer, the program branches to step 98 at which the selected scheduled work shift position is placed on a list of positions that have been offered for filling by other entities. This list may be the same as the auction list described previously in which case the bidding procedure depicted in FIG. 4 is used to fill the work shift position. Alternatively, a separate list of offered work shift positions is maintained from which the first person desiring a listed position is assigned to it using a process that will be described subsequently herein. An amount of reward points associated with the employee offering an assigned work shift for auction is added at step 99 to balances in fields 36, 37 and 38 in the worker's profile record 20.

When the employee accessing the host computer 12 will be trading scheduled assignments, the procedure advances to step 100 at which a determination is made whether other scheduled work shift positions are available for trading. When a work schedule is created, the respective supervisors may designate that particular work shift positions are not available for trading. There may be instances where a supervisor does not want any shift schedule changes to occur, or only wants a particular scheduled employee to work the particular shift position. If the host computer 12 determines that there are no other work shifts assignments available for trading, the process terminates at step 100.

However, if other scheduled work shift positions are available for trading, program execution branches to step 102 where a list of those assignments with the same job classification as the present employee are displayed on the monitor of the personal computer 16 or 19 that is being used. By limiting the assignments being displayed in this manner precludes the exchange of positions where one of the employees involved is not qualified to perform the new work shift position. Then, at step 104, the employee accessing the system chooses one of the available schedules work shift positions to be exchanged for the present employee's scheduled assignment.

Once that selection has been made, the program execution advances to step 106 at which a check is made to determine whether both of the work assignments to be traded are within the same calendar week. This requirement eliminates a possibility that a trade will entitle one or both of the employees involved to receive overtime compensation. In other words, trading a work assignment scheduled for this week for one during next week could result in an employee working more than forty hours next week, thus accruing overtime compensation. This requirement is optional and could be eliminated in configuration of the present procedure for a given employer. If the same week requirement is not satisfied, the process branches to step 108 where the trade is disqualified and the employee is notified of this requirement violation.

Otherwise, the process advances to step 110 where a decision is made whether the trade is valid. This check verifies that the job requirements for both positions being exchanged are satisfied by the respective employees. For example, although the two positions have the same job class, one assignment may require special training or skills that not every employee associated with that job class possesses. These qualifications are indicated in the work credential field 29 of the employees record as shown in FIG. 2. Another validity check involves ensuring that both work shift positions are scheduled for approximately the same number of hours. This avoids the situation where a relatively short work assignment (e.g. four hours) is traded for a significantly longer (e.g. 12 hour) assignment. The software can be configured so that the two work assignments must be identical in duration or have a difference of less than a specified number of hours in order for a trade to occur. In the event that the proposed trade is determined to be invalid at step 110, the program execution branches to step 112 where a determination is made whether the software permits manual override by a supervisor of an otherwise invalid trade. The software also may enable the employee to initiate a supervisor override request, as in the case where this trade would result in overtime for the employee, but the employee also is trading way another assignment thus avoiding overtime. The work shift position trading routine can be configured to automatically reject any invalid trade in which case the process jumps to step 108 where the trade is disqualified and the proposing employee is notified as such.

When the trade is determined to be valid at step 110, the procedure advances to step 114 where a determination is made whether the system has been configured to require supervisor approval of all trades or whether automatic approval is implemented. When either such approval is required or when an invalid trade can be manually overridden at step 112, the program execution reaches step 116 where a supervisor is notified of the issue and asked to either approve or deny the trade. Denial causes the supervisor to provide a comment at step 118 explaining the reasons therefor to the employee proposing the trade. Then, at step 120 that employee is notified of the trade denial.

Alternatively, when the supervisor manually approves a trade at step 116, the process advances through step 122 where comments can be provided to one or both of the employees involved. When either supervisor approval is not required at step 114, or a supervisor has approved and issued comments at step 122, the program ultimately reaches step 124 at which the host computer 12 revises the work schedule according to trade. An amount of reward points associated completing a work shift trade is added at step 125 to balances in fields 36, 37 and 38 in each worker's profile record 20. In some cases some reward points may be given to an employee who offers a work shift assignment even though another employee does not accept that offer or the change was rejected by a supervisor. Then, at step 126 the two employees involved are notified of the trade and their revised work schedules.

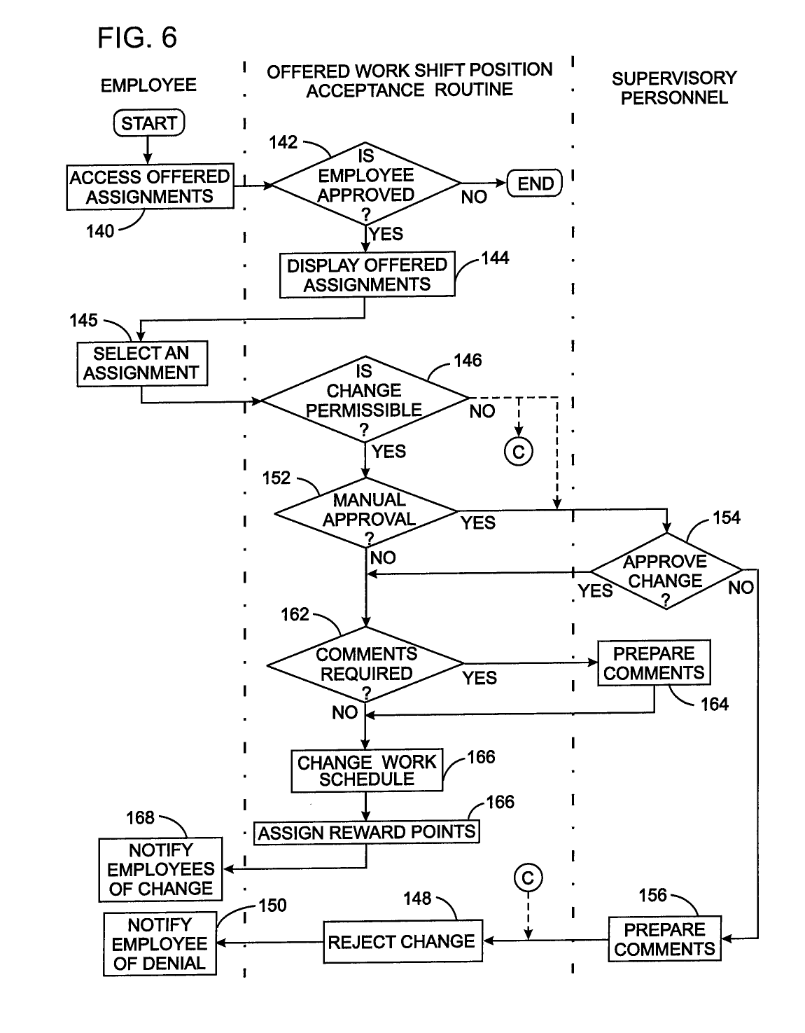

As noted previously, the work schedule alteration software program allows an employee to offer a previously scheduled work assignment for other employees to work. FIG. 6 represents the process by which employees can examine the list of the offered work assignments and agree to fill them. This process begins with step 140 at which an employee utilizes a personal computer 16 or 19 to access an offered work shift position acceptance routine executed by the host computer 12. At step 142, that routine determines whether this particular employee is approved to accept to work assignments being offered. As noted previously, a new employee or one on disciplinary probation may not be permitted to change a work schedule. If that is the case, the offered work shift position acceptance routine terminates.

Assuming that the employee is permitted to participate in the offered work shift position acceptance routine, the procedure advances to step 144 where the scheduled work shift positions being offered to other employees are displayed on the personal computer. The employee then reviews the list and may accept a particular listed assignment at step 145.

Upon selecting an offered assignment, the procedure advances to step 146 where a determination is made whether the proposed schedule change is permissible. This check is similar to the previous validity checks for trading or bidding on a work shift position. For example, a determination is made whether the present employee has the qualifications for the selected assignment and whether making this change will necessitate the payment of overtime compensation. If the assignment change is not permissible, the procedure may jump to step 148 where the bid is automatically disqualified and the employee is notified of that disqualification at step 150. Alternatively, the software may be configured to allow a supervisor to override any disqualification of a proposed change. In that case, the program execution branches to step 154 where the appropriate supervisor for this scheduled work shift position is notified and afforded the opportunity to accept the offered change. If the supervisor denies the change, then an explanation of the denial can be entered at step 156 before the rejection is entered in the host computer 12 at step 148 and the employee is notified at step 150.

If the software determines the proposed change to be permissible at step 146, the process advances to step 152 where a decision is made whether the process is configured to require supervisor approval of all offered work schedule changes. If such approval is required, the program branches to step 154 where the appropriate supervisor is notified and requested to either approve or deny the proposed schedule change.

When the change is authorized, either automatically by the offered work shift position acceptance routine or through the manual approval by a supervisor, a determination is made by the program at step 162 whether the software is configured to require comments regarding every schedule change that is processed. If this is the case, the supervisor is requested to prepare comments at step 164. The procedure advances to step 166 where an amount of reward points associated with accepting an offered work shift position is added to balances in fields 36, 37 and 38 in the worker's profile record 20. Next at step 167, the work schedule is changed to reflect the present employee filling the offered assignment and both the employee who was originally scheduled for the work assignment and the newly scheduled employee are notified of the change at step 168.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A method implemented by a computer system for staffing work schedule having a plurality of work shift positions, said method comprising:
electronically designating at least one of the plurality of work shift positions as an available work shift position;
the computer system receiving a plurality of bids each of which specifying an entity, a given available work shift position, and a wage at which the entity is willing to be compensated for providing a worker for the given available work shift position;
selecting one of the plurality of bids as a selected bid; and
the computer system scheduling the entity associated with the selected bid to work the given available work shift position.

2. The method as recited in claim 1 wherein the entity is an employment agency.

3. The method as recited in claim 1 wherein the entity is a worker at a facility where work at the given available work shift position will be performed.

4. The method as recited in claim 1 wherein selecting one of the plurality of bids as a selected bid is performed by the computer system and is based on the selected bid containing the lowest wage among all bids received for the given available work shift position.

5. The method as recited in claim 1 further comprising a person preventing scheduling the entity associated with the selected bid to work the given available work shift position.

6. The method as recited in claim 1 further comprising notifying the entity associated with the selected bid about being selected to work the given available work shift position.

7. The method as recited in claim 1 further comprising sending a notice to at least some entities from which a bid was received for the given available work shift position.

8. The method as recited in claim 1 further comprising:
storing in the computer system a plurality of profile records each of which identifying any qualification possessed by an entity that may submit a bid;
for each available work shift position storing criteria data identifying any qualification that must be possessed by a worker for the respective available work shift position; and
the computer system disqualifying a bid from an entity when the worker does not possess a qualification for the given available work shift position.

9. The method as recited in claim 8 further comprising a person reviewing the computer system disqualifying the bid and enabling the entity associated with a disqualified bid to be scheduled to work the given available work shift position.

10. The method as recited in claim 1 further comprising specifying a period of time during which bids may be submitted for the available work shift position; and rejecting any bid that is submitted outside the period of time.

11. A method implemented by a computer system for assigning workers to work shift positions, said method comprising:
a first worker electronically selecting, as a first position, a work shift position at which the worker has been scheduled to work;
the first worker electronically selecting, as a second position, another work shift position at which a second worker has been scheduled to work;
the computer system determining whether the first position and the second position satisfy predefined criteria for worker exchange thereby making an exchange determination; and
in response to the exchange determination, the computer system scheduling the first worker to work the second position and scheduling the second worker to work the first position.

12. The method as recited in claim 11 wherein determining whether the first position and the second position satisfy predefined criteria for worker exchange comprises:
storing in the computer system a first profile record identifying any qualifications possessed by the first worker and a second profile record identifying any qualifications possessed by the second worker;
storing in the computer system any qualifications that must be possessed by a worker for the first work shift position, and any qualifications that must be possessed by a worker for the second work shift position; and
making the exchange determination in response to the first worker possessing qualifications that must be possessed by a worker for the second work shift position, and the second worker possessing qualifications that must be possessed by a worker for the first work shift position.

13. The method as recited in claim 11 wherein the predefined criteria requires that both the first position and the second position occur within a predefined period of time.

14. The method as recited in claim 11 further comprising a person changing the exchange determination.

15. The method as recited in claim 11 further comprising issuing a reward to at least one of the first worker and the second worker.

16. A method for assigning a worker to a work shift position that is part of a work schedule stored in a computer system, said method comprising:
the worker offering to work the work shift position;
the computer system validating or invalidating the worker as being capable of performing the work shift position based on a defined validation criteria;
if the worker is validated, the computer system scheduling the worker to work the work shift position; and
issuing a reward to the worker for participating in the method.

17. The method as recited in claim 16 wherein the reward is a perquisite associated with employment of the worker.

18. The method as recited in claim 16 wherein the reward has a monetary value.

19. The method recited in claim 16 wherein the reward comprises a number of points; and further comprising purchasing an item with an accumulated amount of points.
